(19) United States
(12) Patent Application Publication
(10) Pub. No.: US 2002/0017857 A1
(43) Pub. Date: Feb. 14, 2002

(54) Flat-type light-emitting device

(75) Inventors: Masafumi Hashimoto, Shiga (JP); Maki Minamoto, Shiga (JP); Hisashi Yoshida, Shiga (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/912,595

(22) Filed: Jul. 26, 2001

(30) Foreign Application Priority Data
Jul. 26, 2000 (JP) 2000-225294

(51) Int. Cl. H01J 1/62

(52) U.S. Cl. 313/496

(57) ABSTRACT

A flat-type light-emitting device having an approximately even distribution of the light intensity is provided without luminance degradation. This device comprises (a) an envelope having an inner space and an inner surface; the inner space being filled with a discharge medium; (b) a phosphor layer formed in the inner space of the envelope; (c) a first electrode formed on the inner surface of the envelope; the first electrode including linear parts; each of the linear parts having branches apart from each other at a first gap; and (d) a second electrode formed on the inner surface of the envelope adjacent to the first electrode; the second electrode including linear parts; each of the linear parts having branches apart from each other at a second gap. The linear parts of the first electrode and the linear parts of the second electrode are arranged alternately in the direction.

### BACKGROUND OF THE INVENTION

1. Field of the Invention

The present invention relates to a light-emitting device usable as a light source for various equipment and more particularly, to a flat-type light-emitting device applicable to the backlight for Liquid-Crystal Displays (LCDs), or the light source for photocatalyst apparatuses, or any other apparatuses.

2. Description of the Related Art

A prior-art flat-type light-emitting device designed for the backlight of LCDs is disclosed in the Japanese Non-Examined Patent Publication No. 6-231731 published in 1994. This device has a structure as shown in FIG. 1.

In FIG. 1, the prior-art flat-type light-emitting device 51 comprises a rectangular front flat plate 52 made of transparent glass, a rectangular rear flat plate 53 made of transparent glass, and a frame member 54 made of transparent glass disposed between the plates 52 and 53. The front and rear plates 52 and 53 are fixed together by the frame member 54 using frit glass 55 in such a way as to be overlapped with each other at a specific distance. The plates 52 and 53 and the member 54 form a sealed envelope including the inner space 61. An exhausting tube (not shown) is attached to the envelope; however, this tube is omitted in FIG. 1 for simplification of description.

A phosphor layer 56 is formed on the inner surface of the front plate 52 in the space 61. The layer 56 includes an appropriate phosphor material that emits visible light due to excitation by vacuum ultraviolet (UV) rays generated by discharge in the space 61.

A pair of comb-shaped electrodes 57 and 58 is formed on the inner surface of the rear plate 53 in the space 61. These electrodes 57 and 58, which are opposite to each other, are formed by a process of screen printing, evaporation, or the like. A dielectric layer 59 is formed on the inner surface of the rear plate 53 in the space 61, covering entirely the electrodes 57 and 58. The layer 59 too is formed by a process of screen printing or evaporation. A protection layer 60 is formed on the dielectric layer 59 in the space 61, covering entirely the layer 59. The layer 60 too is formed by a process of screen printing or evaporation.

The space 61 is filled with an appropriate discharge medium, such as xenon (Xe) or mercury (Hg) vapor.

The detailed structure of the pair of comb-shaped electrodes 57 and 58 is shown in FIG. 2, which is a popular one. Another example is disclosed in the Japanese Non-Examined Patent Publication 62-193053 published in 1987.

The electrode 57 has n linear parts 57-1 to 57-n interconnected by a linear connection part 57A, where n is an integer greater than unity. The linear parts 57-1 to 57-n are arranged at equal intervals along the connection part 57A. The linear parts 57-1 to 57-n are parallel to each other and perpendicular to the connection part 57A. A feeding part 57B is formed at one end of the connection part 57A.

Similarly, the electrode 58 has n linear parts 58-1 to 58-n interconnected by a linear connection part 58A. The linear parts 58-1 to 58-n are arranged at equal intervals along the connection part 58A. The linear parts 58-1 to 58-n are parallel to each other and perpendicular to the connection part 58A. A feeding part 58B is formed at one end of the connection part 58A.

The connection parts 57A and 57B are located in parallel to each other. The linear parts 57-1 to 57-n and the linear parts 58-1 to 58-n are arranged alternately along the connection parts 57A and 58A.

During the operation of the prior-art light-emitting device 51, an alternative current (ac) voltage having a frequency of 50 to 125 kHz is applied across the comb-shaped electrodes 57 and 58. Thus, ac discharge is caused in the space 61 by way of the dielectric layer 59 and the protection layer 60. The amplitude of the ac voltage is adjusted to exceed the specific discharge voltage of the discharge medium confined in the space 61. Thus, vacuum UV rays are emitted from the discharge medium excited by the discharge in the space 61 and then, they are irradiated to the phosphor layer 56. In response to the irradiation of the UV rays, the layer 56 emits visible light. Since the electrodes 57 and 58 are arranged on approximately the entire inner surface of the rear plate 53, a wide discharge area is formed. Thus, the device 51 serves as a surface-emitting light source.

With the prior-art light-emitting device 51 shown in FIGS. 1 and 2, there is a problem that it is not easy to cause stable discharge simultaneously between all the opposing linear parts 57-1 to 57-n of the electrode 57 and the linear parts 58-1 to 58-n of the electrode 58. For example, as shown in FIG. 3A, stable discharge occurs alternately between the opposing parts 57-1 and 58-1, 57-2 and 58-2, . . . , and 57-n and 58-n, where P1, P3, P5, . . . denote discharge paths. Thus, a stripe-shaped light-emitting area is formed. In other words, the prior-art device 51 has a conspicuously uneven or non-uniform distribution of visible light emitted.

Therefore, if the prior-art device 51 is used as the backlight of a LCD, the luminance distribution in the display area of the LCD is conspicuously uneven, resulting in remarkable degradation in display quality. If the prior-art device 51 is used as the UV light source of a photocatalyst apparatus, the photocatalyst effect or function is instable and/or insufficient. These problems can be suppressed by decreasing the pitch or interval of the linear parts 57-1 to 57-n and 58-1 to 58-n of the electrodes 57 and 58. This is because the non-emitting areas between the parts 57-1 to 57-n and 58-1 to 58-n are narrowed and thus, the apparent luminance distribution is improved to some degree. In this case, however, there arises another problem that the luminance itself degrades drastically due to discharge efficiency deterioration.

### SUMMARY OF THE INVENTION

Accordingly, an object of the present invention is to provide a flat-type light-emitting device having an approximately even or uniform distribution of the light intensity without luminance degradation.

Another object of the present invention is to provide a flat-type light-emitting device that makes it possible to form stable discharge paths between all the adjoining linear parts of electrodes in the inner space of the envelope.

The above objects together with others not specifically mentioned will become clear to those skilled in the art from the following description.

A flat-type light-emitting device according to the present invention comprises:

(a) an envelope having an inner space and an inner surface; the inner space being filled with a discharge medium;

(b) a phosphor layer formed in the inner space of the envelope;

(c) a first electrode formed on the inner surface of the envelope;

the first electrode including linear parts;

each of the linear parts having branches apart from each other at a first gap; and

(d) a second electrode formed on the inner surface of the envelope adjacent to the first electrode;

the second electrode including linear parts;

each of the linear parts having branches apart from each other at a second gap;

wherein the linear parts of the first electrode and the linear parts of the second electrode are arranged alternately in the direction.

With the flat-type light-emitting device according to the present invention, each of the linear parts of the first electrode has the branches apart from each other at the first gap while each of the linear parts of the second electrode has the branches apart from each other at the second gap. The linear parts of the first electrode and the linear parts of the second electrode are alternately arranged in the direction.

Therefore, a discharge path is stably formed between any one of the branches of each of the linear parts of the first electrode and an adjoining one of the branches of each of the linear parts of the second electrode when an appropriate voltage is applied across the first and second electrodes. Thus, discharge areas are formed at both sides of each of the linear parts of the first and second electrodes. This means that an approximately even or uniform distribution of the light intensity is realized without luminance degradation.

In a preferred embodiment of the device according to the invention, the discharge medium emits vacuum UV rays, and the phosphor layer emits visible light due to the vacuum UV rays. The envelope allows the visible light to penetrate through the envelope to the outside. In this embodiment, the device is applicable to a backlight of a LCD.

In another preferred embodiment of the device according to the invention, the discharge medium emits vacuum UV rays, and the phosphor layer emits near UV light due to the vacuum UV rays. The envelope allows the near UV light to penetrate through the envelope to the outside. Preferably, the envelope allows the near UV light having a wavelength of 300 nm or greater to penetrate through the envelope to the outside at a transmittance of approximately 50% or greater. In this embodiment, the device is applicable to a photocatalyst apparatus.

In still another preferred embodiment of the device according to the invention, a photocatalyst layer is additionally formed on an outer surface of the envelope. In this embodiment, there is an additional advantage that the device itself serves as a photocatalyst apparatus.

In a further preferred embodiment of the device according to the invention, the first gap and the second gap are equal to d (mm) that satisfies a relationship of 0.5≦d≦G/2, where G (mm) is a distance between the first inner surface of the envelope and the second inner surface thereof. In this embodiment, the first and second gaps, where no discharge occurs, are sufficiently narrowed with respect to the discharge areas. Thus, there is an additionally advantage that the light intensity distribution of the device is substantially even or uniform.

In a still further preferred embodiment of the device according to the invention, the first electrode has an outermost linear part that has no branch and the second electrode has an outermost linear part that has no branch. In this embodiment, there is an additionally advantage that the total discharge area is increased.

In a still further preferred embodiment of the device according to the invention, a dielectric layer is additionally formed to cover the linear parts of the first electrode and the linear parts of the second electrodes. A protection layer is formed on the dielectric layer. In this embodiment, there is an additional advantage of an extended lifetime of the device.

### BRIEF DESCRIPTION OF THE DRAWINGS

In order that the present invention may be readily carried into effect, it will now be described with reference to the accompanying drawings.

FIG. 1 is a partial, schematic cross-sectional view showing the structure of a prior-art flat-type light-emitting device.

FIG. 2 is a partial, schematic plan view showing the structure of the pair of comb-shaped electrodes of the prior-art device shown in FIG. 1.

FIG. 3A is a partial, schematic cross-sectional view showing the discharge paths formed in the prior-art device of FIG. 1.

FIG. 3B is a partial, schematic plan view showing the discharge paths formed in the prior-art device of FIG. 1.

FIG. 4 is a partial, schematic cross-sectional view showing the structure of a flat-type light-emitting device according to a first embodiment of the invention.

FIG. 5 is a partial, schematic plan view showing the structure of the pair of comb-shaped electrodes of the device according to the first embodiment of FIG. 4.

FIG. 6A is a partial, schematic plan view showing a configuration of the branches of the linear parts of the pair of comb-shaped electrodes of the device according to the first embodiment of FIG. 4.

FIG. 6B is a partial, schematic plan view showing another configuration of the branches of the linear parts of the pair of comb-shaped electrodes of the device according to the first embodiment of FIG. 4.

FIG. 7 is a partial, schematic cross-sectional view showing the structure of a flat-type light-emitting device according to a second embodiment of the invention.

FIG. 8 is a graph showing the UV light transmittance of the glass material used in the device according to the second embodiment of FIG. 7.

FIG. 9 is a schematic view showing the structure of a photocatalyst apparatus that includes the flat-type light-emitting device according to the second embodiment of FIG. 7.

FIG. 10 is a partial, schematic cross-sectional view showing the structure of a flat-type light-emitting device according to a third embodiment of the invention.

### DETAILED DESCRIPTION OF THE PREFERRED EMBODIMENTS

Preferred embodiments of the present invention will be described in detail below while referring to the drawings attached.

### FIRST EMBODIMENT

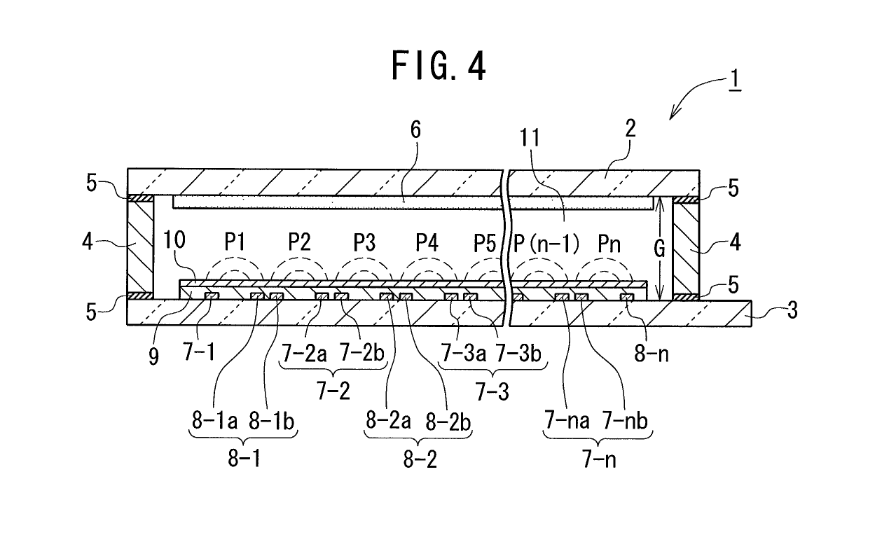

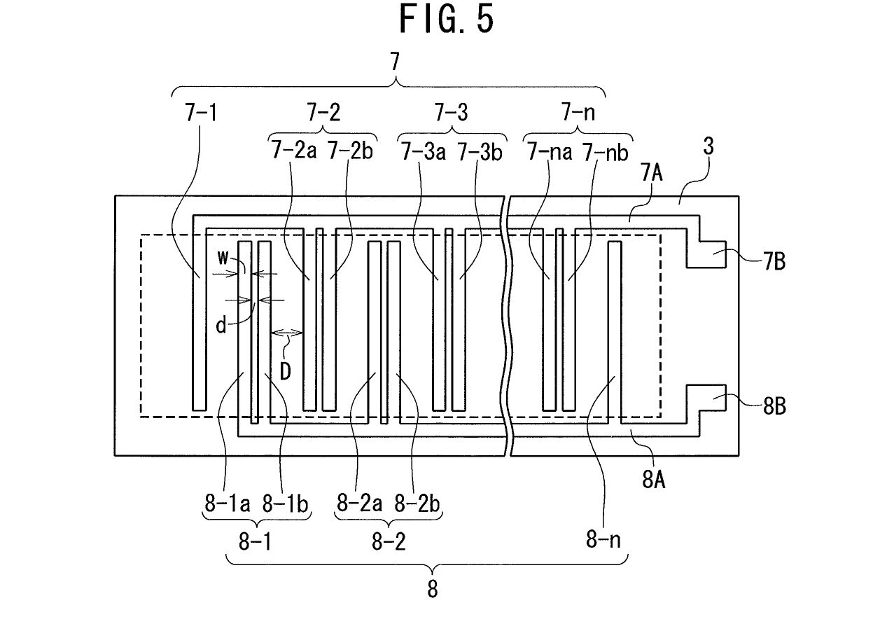

FIGS. 4 and 5 show schematically the structure of a flat-type light-emitting device 1 according to a first embodiment of the invention, which is designed for emitting white light. The device 1, which has a substantially even luminance distribution, is preferably used as the backlight of a LCD.

The light-emitting device 1 comprises a rectangular front flat plate 2 made of transparent glass, a rectangular rear flat plate 3 made of transparent glass, and a frame or side member 4 made of transparent glass and disposed between the plates 2 and 3. For example, the plate 2 has a dimension of 30 mm (in vertical length)×100 mm (in horizontal length)×1.2 mm (in thickness). The plates 2 and 3 and the member 4 are made of a transparent glass such as soda glass. The front and rear plates 2 and 3 are fixed together by the frame member 4 using molten frit glass 5 in such a way as to be almost entirely overlapped with each other at a specific distance. The distance between the opposite inner surfaces of the plates 2 and 3 is defined as G. For example, the distance G is 3 mm. The plates 2 and 3 and the member 4 form a sealed envelope having the inner space 11. An exhausting tube (not shown) is attached to the envelope; however, this tube is omitted in FIG. 4 for simplification.

The inner space 11 of the envelope is filled with an appropriate discharge medium. Here, the medium is a mixture of an inert gas such as argon (Ar) and mercury (Hg) vapor, where the partial pressure of the inert gas is several kilopascals (kPa) to several hundreds kilopascals.

A phosphor layer 6 is formed on the inner surface of the front plate 2 in the space 11. The layer 6 includes an appropriate phosphor material that emits visible light due to excitation by UV light corresponding to the resonance line of Hg at a wavelength of 254 nm, 185 nm, and so on. Preferred phosphor materials are LaPO₄:Tb³⁺, Ce³⁺, and CeMgAl₁₁O₁₉ :Tb³⁺for emitting green light, Y₂O₃:Eu³⁺ for emitting red light, and BaMg₂Al₁₆O₂₇:Eu²⁺ for emitting blue light. If some of these materials with narrow emission ranges for green, red, and blue light are used in combination, high-luminance white light can be emitted. Any phosphor material such as halo-phosphate used for popular fluorescent lamps may be used as the phosphor material of the layer 6.

Instead of Hg, Xe or a Xe-containing inert gas may be used for the discharge medium. In this case, any phosphor material that emits visible light due to excitation by vacuum UV light corresponding to the resonance line of Xe at a wavelength of 147 nm, the molecular line of Xe at a wavelength of 172 nm, and so on may be used. Preferred phosphor materials are BaAl₁₂O₁₉:Mn²⁺ and Zn₂SiO₄:Mn for emitting green light, (Y,Gd)BO₃:Eu³⁺and Y₂O₃:Eu³⁺ for emitting red light, and BaMgAl₁₀O₁₇:Eu²⁺ and BaMgAl₁₄O₂₃:Eu²⁺ for emitting blue light.

The phosphor layer 6 is located on the inner surface of the front plate 2 in the first embodiment. However, the location of the layer 6 is not limited to this. The layer 6 may be located on the inner surface of the rear plate 3 or the side member 4, or on a dielectric or protection layer explained later. The layer 6 may be located at any position in the space 11 of the envelope.

A pair of comb-shaped electrodes 7 and 8 is formed on the inner surface of the rear plate 3. The electrodes 7 and 8, which are made of a silver paste, are formed by a screen-printing process. The electrodes 7 and 8 are several tens micrometers (μm) in thickness.

The electrode 7 has a linear connection part 7A, a feeding part 7B formed at one end of the connection part 7A, and n linear parts 7-1 to 7-n connected to the connection part 7A. The linear parts 7-1 to 7-n are arranged in parallel to each other at equal intervals along the connection part 7A. All the linear parts 7-1 to 7-n are perpendicular to the connection part 7A.

Similarly, the electrode 8 has a linear connection part 8A, a feeding part 8B formed at one end of the connection part 8A, and n linear parts 8-1 to 8-n connected to the connection part 8A. The linear parts 8-1 to 8-n are arranged in parallel to each other at equal intervals along the connection part 8A. All the linear parts 8-1 to 8-n are perpendicular to the connection part 8A.

The linear parts 7-1 to 7-n of the electrode 7 and the linear parts 8-1 to 8-n of the electrodes 8 are alternately arranged at equal intervals along the connection part 7A and 8A.

A transparent dielectric layer 9 is formed on the inner surface of the rear plate 3 to cover the linear parts 7-1 to 7-n of the electrode 7 and the linear parts 8-1 to 8-n of the electrode 8. The layer 9 is made of a glass with a low melting point, such as lead oxide (PbO). The layer 9 is formed by a screen printing process. The layer 9 prevents the dielectric breakdown due to discharge in the space 11 and at the same time, it prevents the electrodes 7 and 8 from being damaged due to discharge.

A protection layer 10 is formed on the dielectric layer 9 to cover entirely the layer 9. The layer 10, which is made of magnesium oxide (MgO), is formed by a screen printing process. The layer 10 reduces the discharge voltage and protects the dielectric layer 9 from discharge. Since the layer 10 has a secondary-electron emitting function and a charge-storing function, the discharge initiation is facilitated and at the same time, the layer 10 restrains the parts or elements of the device 1 from degrading to thereby improve the lifetime of the device 1.

The detailed configuration of the electrodes 7 and 8 is shown in FIG. 5, in which the front plate 2, the frame or side member 4, and so on are omitted for clarification. The rectangular broken line in FIG. 5 denotes the position of the inner edges of the walls of the envelope.

As shown in FIG. 5, the connection parts 7A and 8A of the electrodes 7 and 8 are located parallel to each other along the long sides of the rear plate 3. The feeding parts 7B and 8B of the electrodes 7 and 8 are located in the same end of the plate 3.

Each of the linear parts 7-2 to 7-n of the electrode 7 has two linear branches 7-2a and 7-2b, or 7-3a and 7-3b, . . . , or 7-na and 7-nb. The linear part 7-1, which is located at the opposite end of the electrode 7 to the feeding part 7B, has no branch. All the branches 7-2a and 7-2b, and 7-3a and 7-3b,. . . , and 7-na and 7-nb are parallel to each other. Similarly, each of the linear parts 8-1 to 8-(n-1) of the electrode 8 has two linear branches 8-1a and 8-1b, or 8-2a and 8-2b, . . . , or 8-(n-1)a and 8-(n-1)b. The linear part 8-n, which is located at the same end of the electrode 8 as the feeding part 8B, has no branch. All the branches 8-1a and 8-1b, 8-2a and 8-2b, . . . , and 8-(n-1)a and 8-(n-1)b are parallel to each other.

The linear parts 7-1 to 7-n of the electrode 7 and the linear parts 8-1 to 8-n of the electrode 8 are arranged alternately along the long sides of the rear plate 3 (i.e., along the connection parts 7A and 8A). Therefore, the linear part 7-1, the respective pairs of the branches 7-2a and 7-2b to 7-na and 7-nb, the respective pairs of the branches 8-1a and 8-1b to 8-(n-1)a and 8-(n-1)b, and the linear part 8-n are arranged alternately along the long sides of the rear plate 3.

To cause desired discharge in the space 11 of the envelope, an appropriate ac voltage is applied across the electrodes 7 and 8 at the feeding parts 7B and 8B. In this state, the linear part 7-1 and all the branches 7-2a and 7-2b to 7-na and 7-nb are in the same electric potential while the linear part 8-n and all the branches 8-1a and 8-1b to 8-(n-1)a and 8-(n-1)b are in the same electric potential. Thus, ac discharge will occur between any one of the linear part 7-1 and the branches 7-2a and 7-2b to 7-na and 7-nb and a corresponding, adjoining one of the linear part 8-n and the branches 8-1a and 8-1b to 8-(n-1)a and 8-(n-1)b.

Next, a fabrication method of the flat-type light-emitting device 1 according to the first embodiment is explained below.

First, a patterned silver paste layer is formed on the inner surface of the rear plate 3 made of a soda glass by a screen printing process. Then, the silver paste layer thus formed is dried and sintered, forming the pair of comb-shaped electrodes 7 and 8.

Next, a patterned PbO-based dielectric layer is formed on the inner surface of the rear plate 3 so as to cover the electrodes 7 and 8 thus formed by a screen printing process. Then, the PbO-based dielectric layer is dried and sintered, forming the dielectric layer 9.

A patterned MgO layer is formed on the dielectric layer 9 thus formed by a screen-printing process. Then, the MgO layer is dried and sintered, forming the protection layer 10.

Subsequently, a dispenser for providing a flit glass is moved along the periphery of the rear plate 3 to surround the protection layer 10, thereby coating selectively the flit glass 5 onto the inner surface of the plate 3 in its peripheral area. Then, the flit glass 5 thus coated is dried. On the other hand, the dispenser is moved along the sealing face of the frame member 4, thereby coating selectively the flit glass 5 onto the face of the member 4. Then, the flit glass 5 thus coated is dried.

Subsequently, the frame member 4 having the flit glass 5 on its upper sealing face is placed on the inner surface of the rear plate 3 in such a way that the lower sealing face of the member 4 is overlapped with the flit glass 5 coated on the plate 3. At the same time as this, an exhaust tube (not shown) is inserted into the member 4 by way of an opening of the member 4 and held in the inserted state. Then, they are sintered so as to melt the flit glass 5 and cooled, thereby fixing the member 4 and the exhaust tube onto the rear plate 3 with the flit glass 5 at the lower sealing face of the member 4.

A phosphor material is selectively coated on the inner surface of the front plate 2 and then, it is dried and sintered, forming the phosphor layer 6 on the plate 2. A frit glass is coated on the peripheral area of the inner surface of the plate 2. The front plate 2 thus obtained is placed on the frame member 4 that has been fixed to the rear plate 3 by way of the flit glass 5. Then, they are sintered so as to melt the flit glass 5 and cooled, thereby fixing the plate 2 onto the member 4. Thus, the envelope having the inner space 11 is formed.

Finally, the envelope is connected to an exhausting apparatus (not shown) by way of the exhausting tube and then, the space 11 of the envelope is degassed under heat. A specific discharge medium is filled into the space 11. The end of the exhausting tube is closed by heating, thereby confining the discharge gas in the space 11. As a result, the flat-type light-emitting device 1 of the first embodiment is produced.

To form the electrodes 7 and 8 having the narrow branches, it is preferred that a conductive paste containing silver (Ag), aluminum (Al), nickel (Ni), copper (Cu), carbon (C), indium tin oxide (ITO), or the like is selectively coated on the inner surface of the rear plate 3 by a screen printing process. This is because this process generates high productivity. In addition, Al, Ni, Cu, ITO, or the like may be selectively deposited with a mask by an evaporation process or a sputtering process. An evaporated or sputtered film of Al, Ni, Cu, ITO, or the like may be selectively etched. These two methods have an advantage of high accuracy. Since the evaporated or sputtered film of Ag, Al, Ni, Cu is less in transparency, it is preferred that the film is located on the inner surface of the envelope through which no light is taken out (for example, on the inner surface of the rear plate 3). Since the ITO film is transparent, it may be located on the front plate 2.

Next, the operation of the light-emitting device 1 according to the first embodiment is explained below.

On operation, an ac sinusoidal voltage having a frequency of 80 kHz and an amplitude greater than the specific discharge voltage is applied across the comb-shaped electrodes 7 and 8 at their feeding parts 7B and 8B. In this state, ac discharge occurs between the respective opposing linear parts 7-1 to 7-n of the electrode 7 and the linear electrodes 8-1 to 8-n of the electrodes 8 in the space 11.

Specifically, ac discharge occurs between the linear part 7-1 of the electrode 7 and the opposing branch 8-1a of the linear part 8-1 of the electrode 8, forming a discharge path P1 in the space 11. At the same time as this, ac discharge occurs between the branch 7-2a of the linear part 7-2 of the electrode 7 and the opposing branch 8-1b of the linear part 8-1 of the electrode 8, forming a discharge path P2 in the space 11. Similarly, ac discharge occurs between the branch 7-2b of the linear part 7-2 of the electrode 7 and the opposing branch 8-2a of the linear part 8-2 of the electrode 8, forming a discharge path P3. Ac discharge occurs between the branch 7-3a of the linear part 7-3 of the electrode 7 and the opposing branch 8-2b of the linear part 8-2 of the electrode 8, forming a discharge path P4.

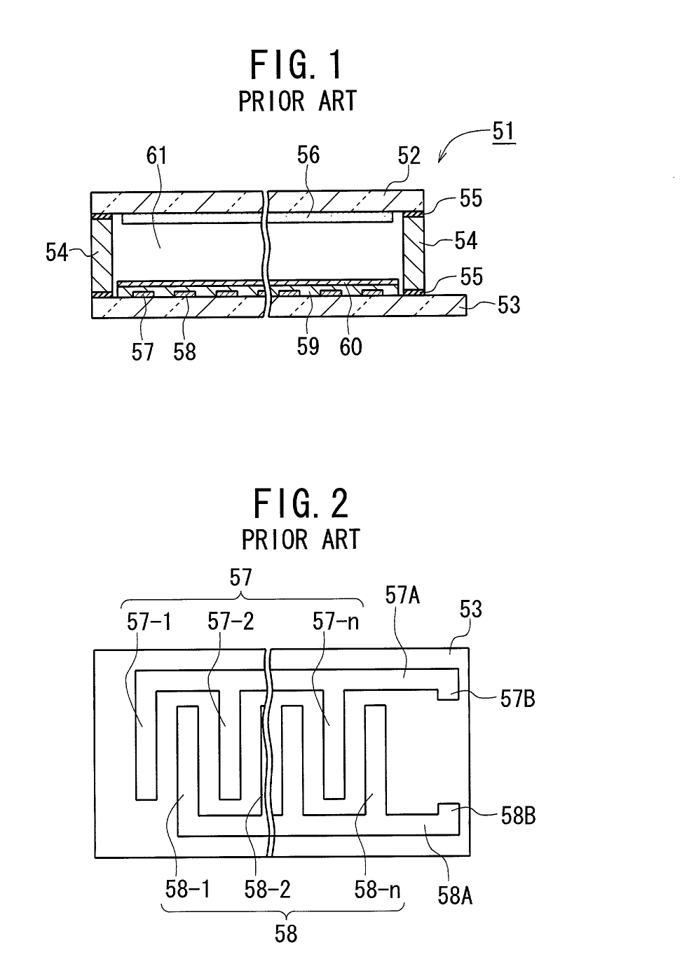

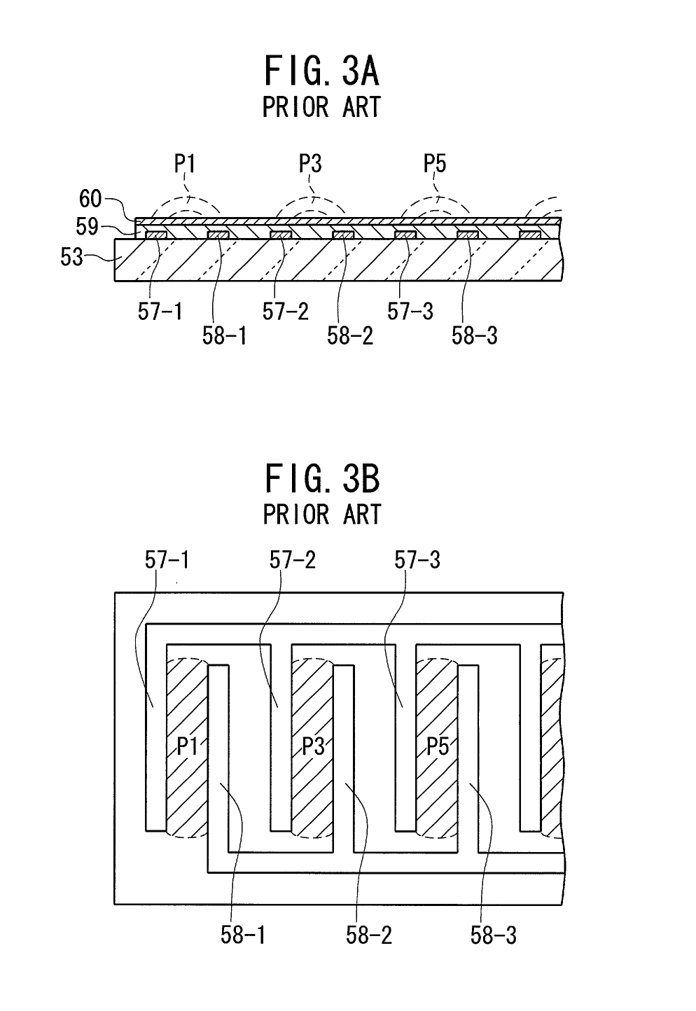

Thus, n discharge paths P1, P2, . . . , P(n-1), and Pn are formed in the space 11, as shown in FIG. 4. In other words, the discharge paths P1 to Pn are formed in the respective areas sandwiched by the adjoining linear parts 7-1 to 7-n and 8-1 to 8-n of the electrodes 7 and 8. As a result, the total discharge area of the light-emitting device 1 according to the first embodiment is approximately twice as wide as the prior-art light-emitting device 51 shown in FIGS. 1 and 2, which increases the luminance of the device 1. Also, the luminance distribution of the device 1 is approximately uniform or even over the whole light-emitting surface of the device 1.

With the light-emitting device 1 according to the first embodiment, as explained above, when the sinusoidal voltage is applied across the electrodes 7 and 8, the branches of each linear part of the electrodes 7 and 8 are in an equal electric potential. Therefore, no discharge occurs between the branches, in other words, no light is emitted from the respective inter-branch areas. To uniformize the luminance distribution, the inter-branch distance d needs to be as small as possible. However, if the distance d is excessively small, the pair of branches serves like a single linear part, which means that the advantage of the invention is not generated. As a result, the distance d has a preferred range.

According to the test by the inventors, it is preferred that the inter-branch distance d (mm) is equal to or greater than 0.5 mm. On the other hand, to uniformize the luminance distribution, it is preferred that the distance d is equal to or less than half of the distance G (mm) of the inner surfaces of the front and rear plates 2 and 3. Thus, the distance d has a preferred range of 0.5 mm≦d≦(G/2) mm.

It is preferred that the inter-branch distance D (mm) between the branch of the electrode 7 and the opposing branch of the electrode 8 is sufficiently larger than the inter-branch distance d as long as the stable discharge occurs therebetween. According to the test by the inventors, the distance D has a preferred range of 2d≦D≦16d. For example, if d=0.5 mm, it is preferred that 1 mm≦D≦8 mm. If D is less than 1 mm, stable discharge occurs; however, the discharge efficiency and luminance is insufficient. If D is greater than 8 mm, discharge path formation is difficult and as a result, the advantage of the invention is not generated sufficiently.

The width W (mm) of each branch needs to be 0.5 mm or greater from the viewpoint of the obtainable dimensional accuracy and the permissible discharge current. The width W needs to be larger as the discharge current increases.

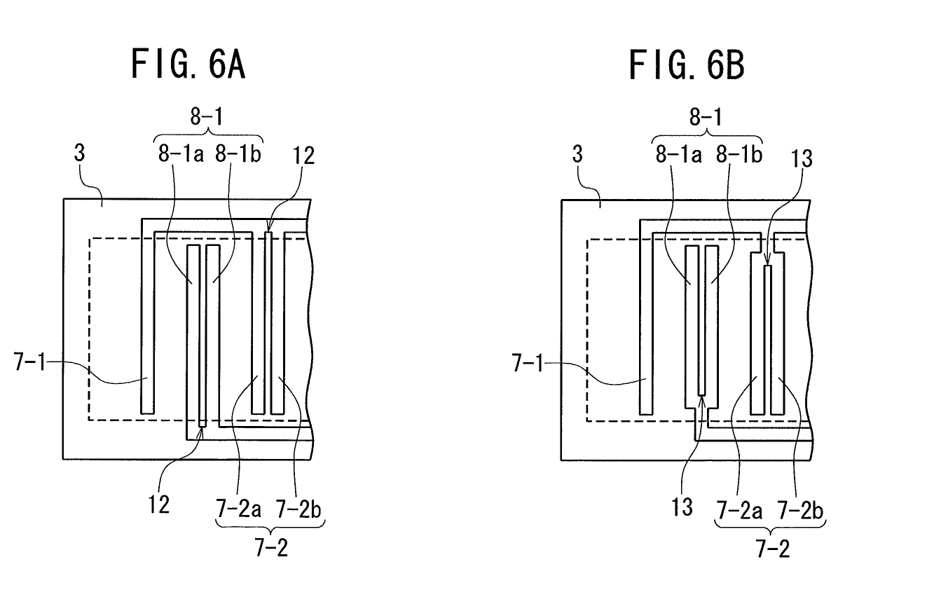

FIGS. 6A and 6B show the branching point of each branch of the electrodes 7 and 8.

The light-emitting device 1 of the first embodiment has the branching point 12 at each branch, as shown in FIG. 6A. All the branching points 12 of the electrodes 7 and 8 are located outside the inner edges of the wall of the envelope indicated by the broken lines. This is to ensure the advantage of the invention. From the viewpoint of the advantage of the invention, it is preferred that all the points 12 are located outside the space 11. However, the invention is not limited to this case. For example, as shown in FIG. 6B, the device 1 may have the branching point 13 at each branch, where all the points 13 are located in the space 11 near the wall of the envelope. In this case, the points 13 are located near the walls and therefore, almost the same advantage as the device 1 of the first embodiment can be given.

In the device 1 of the first embodiment, the outermost linear part 7-1 of the electrode 7 and the outermost linear part 8-n of the electrode 8 are not branched. The part 7-1 has the same shape as any of the branches 7-2a, 7-2b, . . . , 7-na, and 7-nb. The part 8-n has the same shape as any of the branches 8-1a, 8-1b, . . . , 8-(n-1)a, and 8-(n-1)b. This is because the part 7-1 (or, 8-n) is simply used to form the discharge path P1 (or, Pn) along with the opposing branch 8-1a (or, 7-nb) on one side of the part 7-1 (or, 8-n). In other words, no branch of the electrode 8 (or, 7) exists on the other side of the part 7-1 (or, 8-n).

Because of the fact that the outermost linear part 7-1 of the electrode 7 and the outermost linear part 8-n of the electrode 8 are not branched, the inter-branch areas that generate no discharge do not exist near the parts 7-1 and 8-n. Thus, there is an additional advantage that the total discharge area is wider than the case where the outermost linear part 7-1 and the outermost linear part 8-n are branched.

With the light-emitting device 1 according to the first embodiment, as described above, the discharge paths P1 to Pn are stably formed between any one of the branches of each linear part of the electrode 7 and an adjoining one of the branches of each linear part of the electrode 8. Thus, discharge areas are formed at both sides of one of the linear parts of the electrode 7 or 8. This means that an approximately even or uniform distribution of the light intensity is realized without luminance degradation.

Since the device 1 emits visible light, it is usable as a light source for the backlight of LCDs, or a reading light source for the so-called Office Automation (OA) instruments, such as facsimiles, image scanners, copying machines, and so on.

### SECOND EMBODIMENT

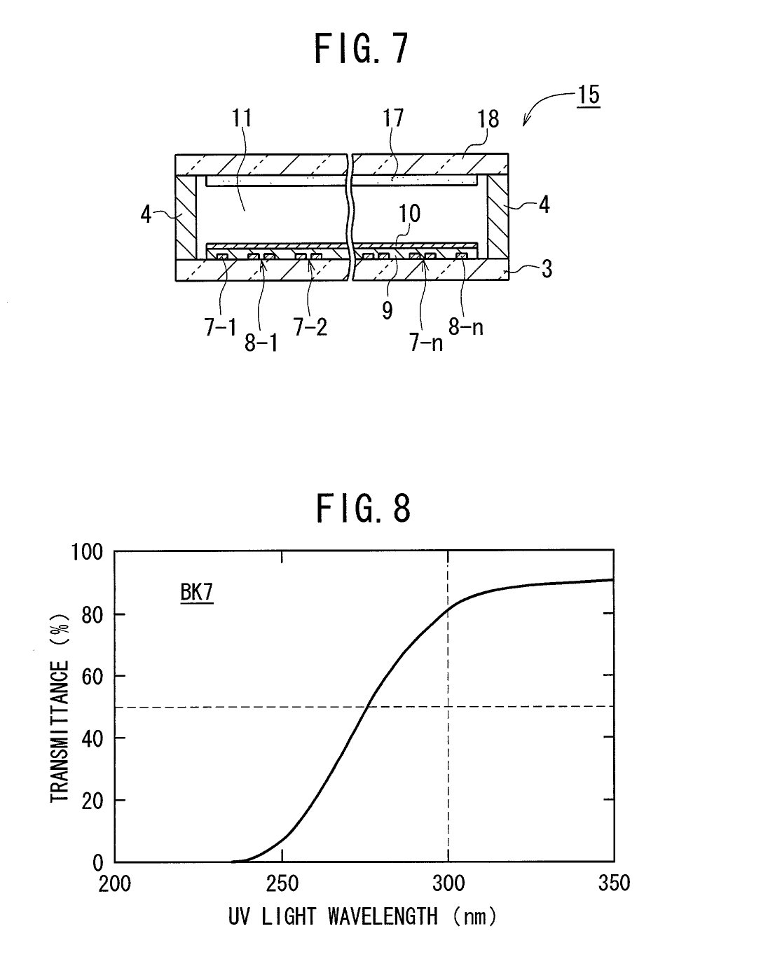

FIG. 7 shows schematically the structure of a flat-type light-emitting device 15 according to a second embodiment of the invention, which is designed for emitting near UV light. The device 15, which has a substantially even luminance distribution, is preferably used as a light source of a photocatalyst apparatus.

The light-emitting device 15 has the same structure as the light-emitting device 1 of the first embodiment except for (i), (ii), and (iii) described below.

(i) A discharge medium that emits vacuum UV rays is filled in the space 11.

(ii) A front plate 18 is provided instead of the front plate 2. The plate 18 is made of a glass that allows near UV light to penetrate through the same effectively.

(iii) A phosphor layer 17 is formed on the inner surface of the front plate 18. The layer 17 has a phosphor material that emits near UV light. The near UV light, which is excited by vacuum UV rays emitted by the discharge medium in the space 11, is used to enhance the photocatalyst effect.

Preferably, the discharge medium is a Xe gas or a Xe-containing gas. It is preferred that the total pressure of the medium is several kilopascals (kPa) to several hundreds kilopascals and that the partial pressure of Xe is several kilopascals to several tens kilopascals. A mixture of Hg with one of Ar, Ne, Kr, and Xe may be used for this purpose.

It is preferred that the phosphor material of the phosphor layer 17 emits near UV light of 300 nm to 400 nm in wavelength, because this light is excited by the vacuum UV rays emitted by the discharge medium and at the same time, it is effective for the photocatalyst effect. Preferred phosphor materials are SrB₄O₇:Eu²⁺(360 nm in wavelength), BaSi₂O₅:Pb²⁺(350 nm in wavelength), YPO₄:Ce³⁺(325 nm in wavelength), (Ba,Sr,Mg)₃Si₂O₇:Pb²⁺(370 nm in wavelength), and (Ba,Mg,Zn)₃Si₂O₇:Pb²⁺(295 nm in wavelength). At least one of these phosphor materials is/are formed to have a single-layer or multilayer structure. If visible light is necessary for illumination purpose in addition to the near UV light, at least one of these phosphor materials that emit near UV light is used along with at least one of the phosphor materials that emit visible light described previously in the first embodiment. In this case, these two types of the phosphor materials are mixed together or combined together as a multilayer structure.

Since the light-emitting device 15 of the second embodiment emits near UV light, the outputting wall of the envelope should have a property that allows near UV light of 300 nm to 400 nm in wavelength to pass through as effectively as possible. Thus, the front plate 18 with such a property is used in the device 15. However, preferably, the rear plate 3 and the side or frame member 4 have the same property as the front plate 18 as well. This is because the total amount of the near UV light emitted from the device 15 is increased.

A preferred material for the front plate 18 (and the rear plate 3 and the frame member 4) is a glass whose ingredients are adjusted in such a way as to have a transmittance of near UV light (wavelength: 300 nm to 400nm) of 50% (more preferably, 80%) or higher. Since ordinary soda glasses have a low transmittance for near UV light within this wavelength range, obtainable photocatalyst effect is insufficient.

According to the test of the inventors, it was found that a boric-acid-based glass “BK7” (which is a product name of the Shot company Ltd.) was preferred for this purpose. The glass “BK7” had a wavelength-transmittance characteristic as shown in FIG. 8. As seen from FIG. 8, the glass “BK7” allows the UV light to pass through. Therefore, when the glass “BK7” is used for the front plate 18 (and the rear plate 3 and the frame member 4), the light-emitting device 15 of the second embodiment produces a desired photocatalyst effect.

Instead of the glass “BK7”, any quartz glass may be used for the plate 18 (and plate 3 and the member 4).

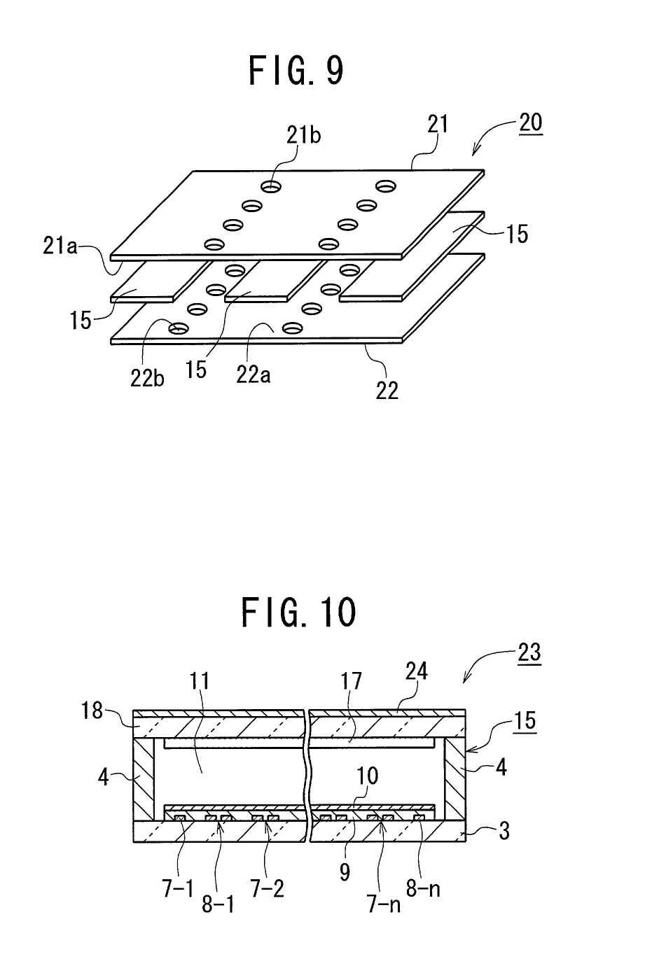

FIG. 9 shows a schematic illustration of a photocatalyst apparatus 20 using the light-emitting device 15 of the second embodiment, which is designed for an air cleaner such as air controllers.

As shown in FIG. 9, a pair of plate-shaped filters 21 and 22 are provided to be apart from each other. Three light-emitting devices 15 of the second embodiment are arranged between the pair of filters 21 and 22. Each of the filers 21 and 22 comprises a solid plate and a photocatalyst layer 21a or 22a formed on the inner surface of the plate. The plate is made of a metal, synthetic resin, ceramic, glass, or the like. The photocatalyst layer 21a or 22a is made of TiO₂ of the anatase crystal type, which is formed on the plate by a process of evaporation, sputtering, Chemical Vapor Deposition (CVD), or coating. Each of the filters 21 and 22 has a plurality of holes 21b or 22b arranged along two lines, through which the air to be cleaned flows.

On operation of the photocatalyst apparatus 20, all the light-emitting devices 15 are activated to emit near UV light through their front plate 18 (and the rear plate 3 and the side member 4). The near UV light thus emitted is irradiated to the photocatalyst layers 21a and 22a of the filters 21 and 22, activating the photocatalyst materials on the inner surfaces of the layers 21a and 22a. Due to the effect of the photocatalyst materials thus activated, the moisture existing in the air near the layers 21a and 22a is decomposed to generate hydroxy radicals with a strong oxidizing property. Organic substances existing in the air is decomposed to carbon dioxide (CO₂) by the oxidizing effect of the hydroxy radicals. At the same time as this, bacterium existing in the air are sterilized by the same oxidizing effect.

The cleaning and sterilizing functions of the photocatalyst apparatus 20 are continuously carried out by circulating the air through the apparatus 20 by way of the holes 21b and 22b. The air may be controlled to flow through the space between the filters 21 and 22 along the filters 21 and 22.

With the photocatalyst apparatus 20, the flat-type light-emitting devices 15 according to the second embodiment are arranged to be parallel to the filters 21 and 22 and therefore, the near UV light from the devices 15 are effectively and approximately uniformly irradiated to the surfaces of the photocatalyst layers 21a and 22a. As a result, the photocatalyst effect is enhanced or improved.

### THIRD EMBODIMENT

FIG. 10 shows schematically the structure of a flat-type light-emitting device 23 according to a third embodiment of the invention, which corresponds to the combination of the flat-type light-emitting device 15 according to the second embodiment with a photocatalyst layer 24. This device 23 itself serves as a simple photocatalyst apparatus.

The light-emitting device 23 has the same structure as the light-emitting device 15 of the second embodiment except that the photocatalyst layer 24 is additionally formed on the outer surface of the front plate 18. The layer 24 is 50 nm to 200 nm in thickness.

Preferred materials for the photocatalyst layer 24 are metal-oxide-based materials that provide a photocatalyst function by absorption of near UV light with a wavelength of 300 nm to 400 nm. TiO₂-based materials of the anatase crystal type are most preferred. Instead of the TiO₂-based materials, ZnO, MgO, Ce₂O₃, Tb₂O₃, WO₃, Fe₂O₃, LaRhO₃, FeTiO₃, SrTiO₃, GaAs, GaP, or RuO₂-based materials or the like may be used for this purpose.

As an example of the method of forming the photocatalyst layer 24, a powder of one of these materials listed as above is dispersed in a binder to form a slurry and then, the slurry is coated on the outer surface of the front plate 18 and dried. Alternately, a solution of an alkoxide compound of a metal having a photocatalyst function is coated on the outer surface of the front plate 18 and sintered. The layer 24 may be formed by a process of electron-beam evaporation, sputtering or CVD.

With the light-emitting device 23 of the third embodiment, near UV light generated from the device 15 is irradiated to the back surface of the photocatalyst layer 24 by way of the front plate 18. Taking this into consideration, to increase the amount of the hydroxy radicals generated near the front surface of the layer 24, the layer 24 is preferably formed to be thin and porous.

An additional photocatalyst layer or layers may be formed on the outer surface of the rear plate 3 and/or on the outer surface of the side member 4 in addition to the photocatalyst layer 24.

### VARIATIONS

It is needless to say that the invention is not limited to the above-described first to third embodiments. Any change may be added to the invention. For example, the shape of the envelope and/or the electrodes 7 and 8 may be changed optionally as long as the advantages of the invention are generated.

While the preferred forms of the present invention have been described, it is to be understood that modifications will be apparent to those skilled in the art without departing from the spirit of the invention. The scope of the present invention, therefore, is to be determined solely by the following claims.

What is claimed is:

1. A flat-type light-emitting device comprising:
(a) an envelope having an inner space and an inner surface;
the inner space being filled with a discharge medium;
(b) a phosphor layer formed in the inner space of the envelope;
(c) a first electrode formed on the inner surface of the envelope;
the first electrode including linear parts;
each of the linear parts having branches apart from each other at a first gap; and
(d) a second electrode formed on the inner surface of the envelope adjacent to the first electrode;
the second electrode including linear parts;
each of the linear parts having branches apart from each other at a second gap;
wherein the linear parts of the first electrode and the linear parts of the second electrode are arranged alternately in the direction.

2. The device according to claim 1, wherein the discharge medium emits vacuum UV rays and the phosphor layer emits visible light due to the vacuum UV rays;
and wherein the envelope allows the visible light to penetrate through the envelope to the outside.

3. The device according to claim 1, wherein the discharge medium emits vacuum UV rays and the phosphor layer emits near UV light due to the vacuum UV rays;
and wherein the envelope allows the near UV light to penetrate through the envelope to the outside.

4. The device according to claim 3, wherein the envelope allows the near UV light having a wavelength of 300 nm or greater to penetrate through the envelope to the outside at a transmittance of approximately 50% or greater.

5. The device according to claim 1, further comprising a photocatalyst layer formed on an outer surface of the envelope.

6. The device according to claim 1, wherein the first gap and the second gap are equal to d (mm) that satisfies a relationship of 0.5≦d≦G/2, where G (mm) is a distance between the first inner surface of the envelope and the second inner surface thereof.

7. The device according to claim 1, wherein the first electrode has an outermost linear part that has no branch and the second electrode has an outermost linear part that has no branch.

8. The device according to claim 1, further comprising
a dielectric layer formed to cover the linear parts of the first electrode and the linear parts of the second electrodes; and
a protection layer formed on the dielectric layer.

9. The device according to claim 1, wherein one of the branches of each of the linear parts of the first electrode is apart from an adjoining one of the branches of each of the linear parts of the second electrode at a dischargeable distance.
